(19) United States
(12) Patent Application Publication
(10) Pub. No.: US 2011/0188449 A1
(43) Pub. Date: Aug. 4, 2011

(54) INTER-DEVICE SESSION DUPLICATION

(75) Inventors: Kamel M. Shaheen, King of Prussia, PA (US); Oscar Lopez-Torres, King of Prussia, PA (US); Debashish Purkayastha, Collegeville, PA (US)

(73) Assignee: INTERDIGITAL PATENT HOLDINGS, INC., Wilmington, DE (US)

(21) Appl. No.: 12/947,369

(22) Filed: Nov. 16, 2010

Related U.S. Application Data
(60) Provisional application No. 61/261,421, filed on Nov. 16, 2009.

(51) Int. Cl. H04W 4/00

(52) U.S. Cl. 370/328

(57) ABSTRACT

A method and apparatus for performing session duplication are provided. A communication session between a first wireless transmit/receive unit (WTRU) and a remote device may be duplicated to add a second WTRU to the communication session without disruption of the communication session on the first WTRU or the remote device. The communication session may be duplicated by a network unit in response to a policy or a communication session duplication request. The first WTRU or the second WTRU may initiate session duplication by transmitting a communication session duplication request. Session duplication may include duplication of one or more media flows associated with the communication session. Session duplication may include transferring or sharing control of the communication session.

### CROSS REFERENCE TO RELATED APPLICATIONS

This application claims the benefit of U.S. Provisional Application No. 61/261,421 filed Nov. 16, 2009, the contents of which are hereby incorporated by reference herein.

### BACKGROUND

A wireless transmit/receive unit (WTRU) may participate in a communication session with a remote unit via an access network, such as a radio access network, for example, a Universal Mobile Telecommunication System (UMTS) Terrestrial Radio Access Network (UTRAN), a Long Term Evolution (LTE) network, a Worldwide Interoperability for Microwave Access (WiMax) network, or a Wireless Local Area Network (WLAN) network. Accordingly, it would be advantageous for a WTRU to duplicate a communication session on a second WTRU.

### SUMMARY

A method and apparatus for performing session duplication are provided. A communication session between a first wireless transmit/receive unit (WTRU) and a remote device may be duplicated to add a second WTRU to the communication session without disruption of the communication session on the first WTRU or the remote device. The communication session may be duplicated by a network unit in response to a policy or a communication session duplication request. The first WTRU or the second WTRU may initiate session duplication by transmitting a communication session duplication request. Session duplication may include duplication of one or more media flows associated with the communication session. Session duplication may include transferring or sharing control of the communication session.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A;

FIG. 2 shows a diagram of an example of an Internet Protocol Multimedia Subsystem;

FIG. 3 shows a diagram of an example of a communication session using third party call control;

FIG. 4 shows a diagram of an example of a communication session using first party call control;

FIG. 5 shows a diagram of an example of a method of session duplication using third party call control;

FIG. 6 is a diagram of an example of a method of session duplication using first party call control;

FIG. 7 shows a diagram of an example of a duplicated communication session using third party call control; and

FIG. 8 shows a diagram of an example of a duplicated communication session using first party call control.

### DETAILED DESCRIPTION

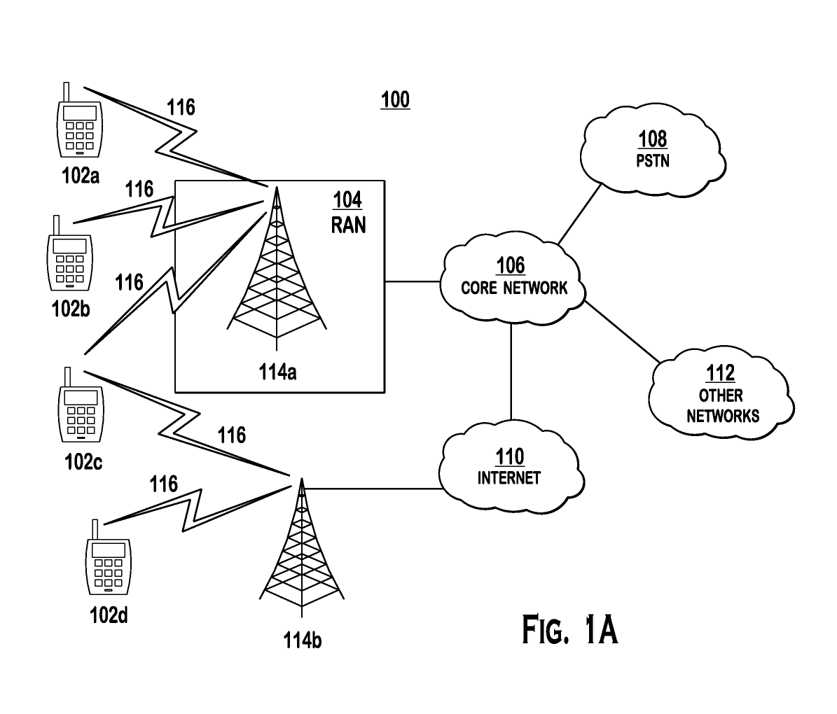

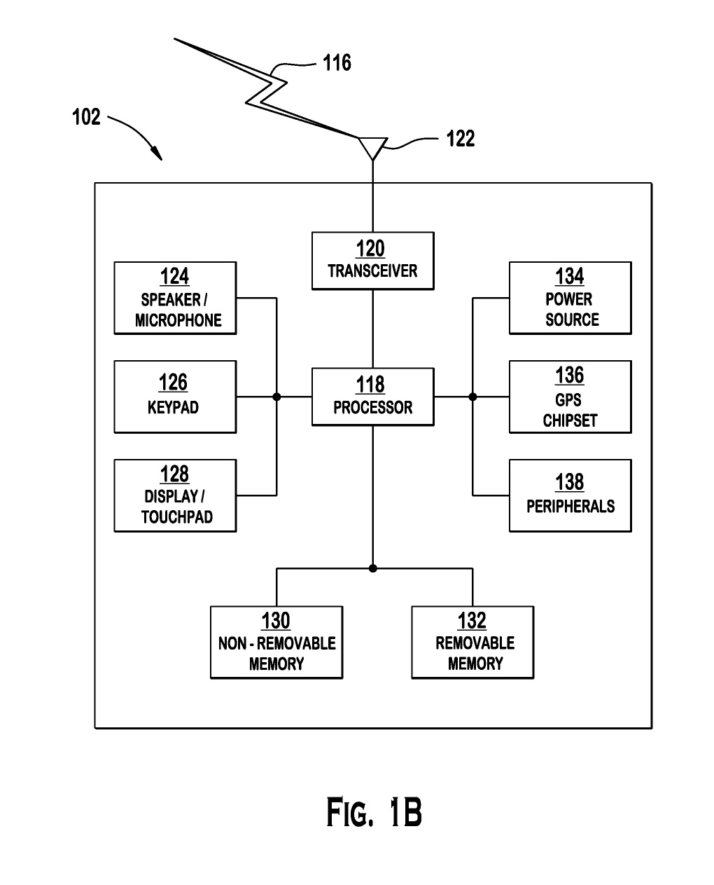

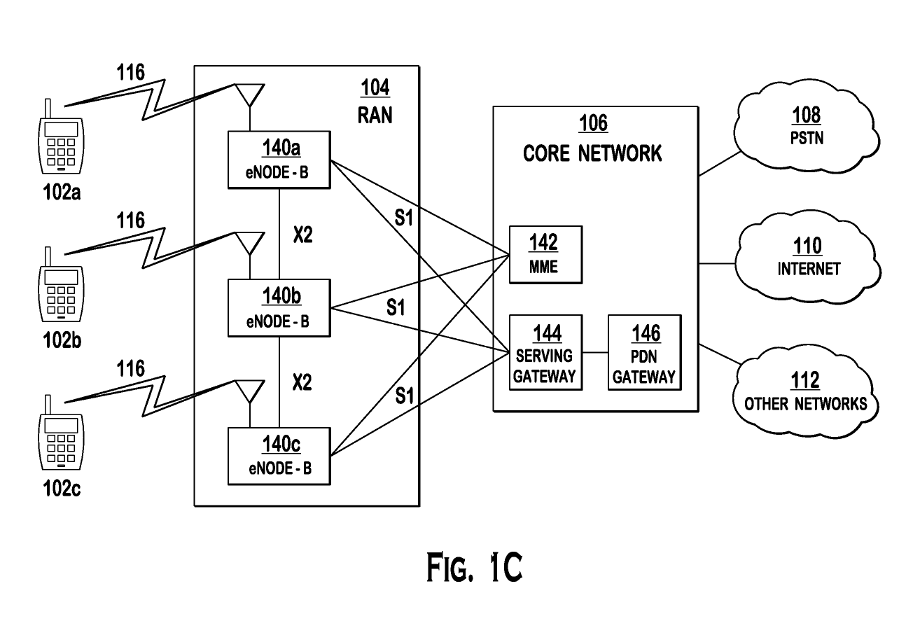

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

Wireless communication may include using an IP Multimedia (IM) Subsystem (IMS). For example, in LTE, as shown in FIG. 1C, or any other RAN/Core network, the Other Networks 112 may include IMS. A communication session using IMS may be transferred, or duplicated, from one WTRU to another.

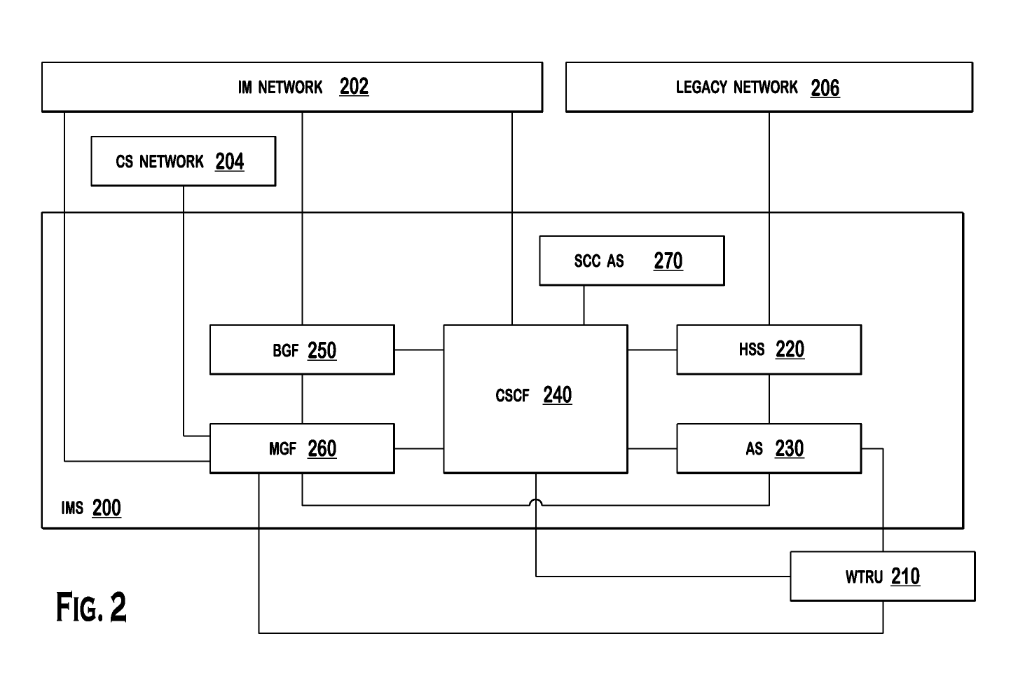

FIG. 2 is a diagram of an example of a Internet Protocol (IP) IP multimedia core network (IM CN), including an IP Multimedia (IM) Subsystem (IMS) 200, an IM network 202, a Circuit Switched (CS) network 204, a legacy network 206, in communication with a wireless transmit/receive unit (WTRU) 210. The IMS 200 includes core network (CN) elements for provision of IM services, such as audio, video, text, chat, or a combination thereof, delivered over the packet switched domain. As shown, the IMS 200 includes a Home Subscriber Server (HSS) 220, an Application Server (AS) 230, a Call Session Control Function (CSCF) 240, a Breakout Gateway Function (BGF) 250, a Media Gateway Function (MGF) 260, and a Service Centralization and Continuity Application Server (SCC AS) 270. In addition to the logical entities and signal paths shown in FIG. 2, an IMS may include any other configuration of logical entities which may be located in one or more physical devices. Although not shown in this logical example, the WTRU may be a separate physical unit and may be connected to the IM CN via a base station such as, a Node-B or an enhanced-NodeB (eNB).

The WTRU 210 may be any type of device configured to operate and/or communicate in a wired and/or wireless environment.

The HSS 220 may maintain and provide subscription-related information to support the network entities handling IM sessions. For example, the HSS may include identification information, security information, location information, and profile information for IMS users.

The AS 230, which may be a SIP Application Server, an OSA Application Server, or a CAMEL IM-SSF, may provide value added IM services and may reside in a home network or in a third party location. The AS may be included in a network, such as a home network, a core network, or a standalone AS network. The AS may provide IM services. For example, the AS may perform the functions of a terminating user agent (UA), a redirect server, an originating UA, a SIP proxy, or a third party call control.

The CSCF 240 may include a Proxy CSCF (P-CSCF), a Serving CSCF (S-CSCF), an Emergency CSCF (E-CSCF), or an Interrogating CSCF (I-CSCF). For example, a P-CSCF may provide a first contact point for the WTRU within the IMS, a S-CSCF may handle session states, and a I-CSCF may provide a contact point within an operator's network for IMS connections destined to a subscriber of that network operator, or to a roaming subscriber currently located within that network operator's service area.

The BGF 250 may include an Interconnection Border Control Function (IBCF), a Breakout Gateway Control Function (BGCF), or a Transition Gateway (TrGW). Although described as a part of the BGF, the IBCF, the BGCF, or the TrGW may each represent a distinct logical entity and may be located in one or more physical entities.

The IBCF may provide application specific functions at the SIP/SDP protocol layer to perform interconnection between operator domains. For example, the IBCF may enable communication between SIP applications, network topology hiding, controlling transport plane functions, screening of SIP signaling information, selecting the appropriate signaling interconnect, and generation of charging data records.

The BGCF may determine routing of IMS messages, such as SIP messages. This determination may be based on information received in the signaling protocol, administrative information, or database access. For example, for PSTN/CS Domain terminations, the BGCF may determine the network in which PSTN/CS Domain breakout is to occur and may select a MGCF.

The TrGW, may be located on the media path, may be controlled by an IBCF, and may provide network address and port translation, and protocol translation.

The MGF 260 may include a Media Gateway Control Function (MGCF), a Multimedia Resource Function Controller (MRFC), a Multimedia Resource Function Processor (MRFP), an IP Multimedia Subsystem—Media Gateway Function (IMS-MGW), or a Media Resource Broker (MRB). Although described as a part of the MGF, the MGCF, the MRFC, the MRFP, the IMS MGW, or the MRB may each represent a distinct logical entity and may be located in one or more physical entities.

The MGCF may control call state connection control for media channels in IMS; may communicate with CSCF, BGCF, and circuit switched network entities; may determine routing for incoming calls from legacy networks; may perform protocol conversion between ISUP/TCAP and the IM subsystem call control protocols; and may forward out of band information received in MGCF to CSCF/IMS-MGW.

The MRFC and MRFP may control media stream resources. The MRFC and MRFP may mix incoming media streams; may source media streams, for example for multimedia announcements; may process media streams, such as by performing audio transcoding, or media analysis; and may provide floor control, such as by managing access rights to shared resources, for example, in a conferencing environment.

The IMS-MGW may terminate bearer channels from a switched circuit network and media streams from a packet network, such as RTP streams in an IP network. The IMS-MGW may support media conversion, bearer control and payload processing, such as, codec, echo canceller, or conference bridge. The IMS-MGW may interact with the MGCF for resource control; manage resources, such an echo canceller; may include a codec. The IMS-MGW may include resources for supporting UMTS/GSM transport media.

The MRB may support the sharing of a pool of heterogeneous MRF resources by multiple heterogeneous applications. The MRB may assign, or releases, specific MRF resources to a call as requested by a consuming application, based on, for example, a specified MRF attribute. For example, when assigning MRF resources to an application, the MRB may evaluate the specific characteristics of the media resources required for the call or calls; the identity of the application; rules for allocating MRF resources across different applications; per-application or per-subscriber SLA or QoS criteria; or capacity models of particular MRF resources.

The SCC AS 270 may provide communication session service continuity, such as duplication, transfer, addition, or deletion of communication sessions, among multiple WTRUs, for example, in a subscription. The SCC AS may perform Access Transfer, Session Transfer or Duplication, Terminating Access Domain Selection (T-ADS), and Handling of multiple media flows. The SCC AS may combine or split media flows over one or more Access Networks. For example, a media flow may be split or combined for Session Transfers, session termination, upon request by the WTRU to add media flows over an additional Access Network during the setup of a session, or upon request by the WTRU to add or delete media flows over one or more Access Networks to an existing sessions.

A communication session may be performed using a communication system, such as the communication system shown in FIG. 1A, between a WTRU, such as the WTRU shown in FIG. 1B, and a remote device. The WTRU may access the communication system via a RAN, such as the RAN shown in FIG. 1C, or any other wired or wireless access network. The communication session may include services, such as IP multimedia (IM) services provided by the IMS as shown in FIG. 2. Although described with reference to IMS herein, session duplication may be performed using any communication system or access network.

The WTRU, the remote device, or the network may control the communication session. Control of the communication session may include, for example, starting or stopping a media flow, adding or removing a media flow, transferring or duplicating a media flow on another WTRU, adjusting a bit-rate, or terminating the communication. For example, a WTRU may initiate a communication session with a remote device. The WTRU may initially control the communication session. The WTRU may pass or share control of the communication session with the remote device.

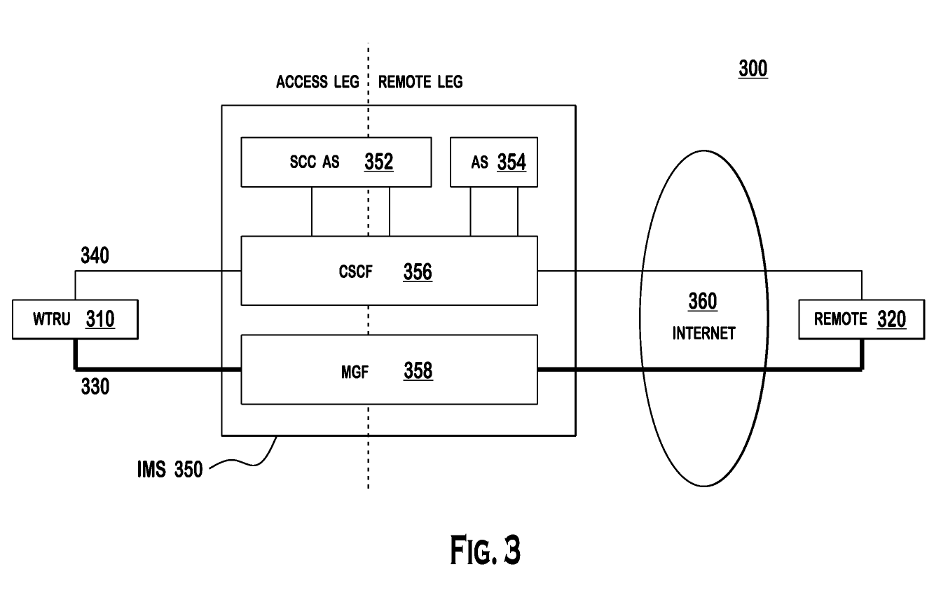

FIG. 3 shows a diagram of an example of a communication session 300 between a WTRU 310 and a remote device 320 using IMS. The communication session 300 may include media flows 330 (media path) and control signaling 340 (control path) between the WTRU 310 and the remote device 320 via a network 350, such as an IM CN as shown in FIG. 2. The IM CN 350 may include an SCC AS 352, an AS 354, a CSCF 356, and a MGF 358.

The communication session 300 may be anchored at the SCC AS 352 associated with the WTRU 310. For example, the SCC AS 352 may maintain information regarding the communication session, such as media flow identifiers and controlling device identifiers, and may provide call control, such as session duplication, for the communication session 300. For simplicity, the part of the communication session between the WTRU 310 and the SCC AS 352 may be referred to as the access leg, and the part of the communication session between the SCC AS 352 and the remote device 320 may be referred to as the remote leg.

To establish a communication session 300 using IMS the WTRU 310 may initiate a connection (access leg) via the IM CN 350. The WTRU 310 may receive the media flows 330 via the MGF 358 and control signaling 340 via the CSCF 356. The remote device 320 may participate in the communication session 300 via a remote network (remote leg), such as via the Internet 360.

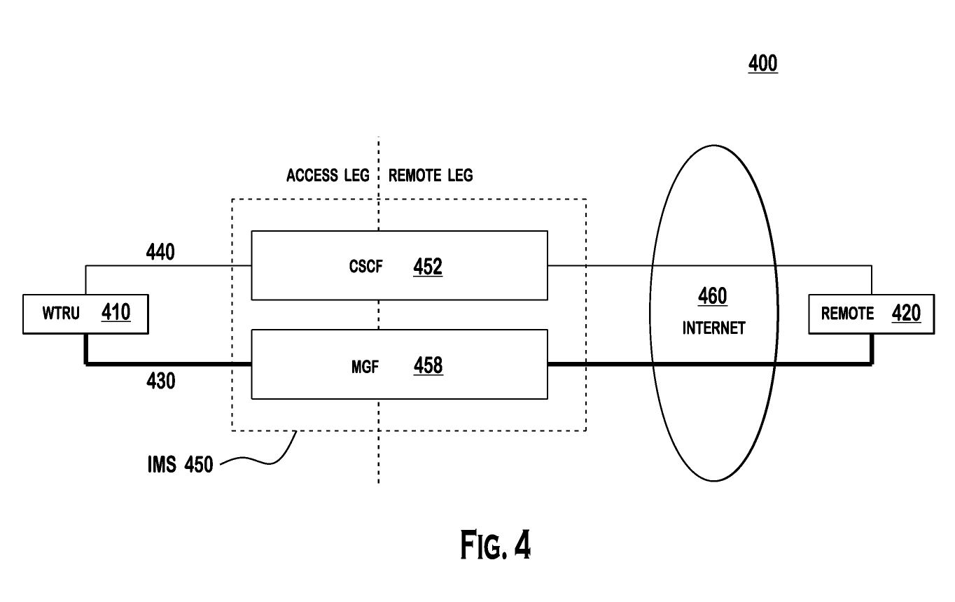

FIG. 4 shows a diagram of an example of a peer-to-peer communication session 400 between a WTRU 410 and a remote unit 420 using IMS. The communication session 400 may include media flows 430 and control signaling 440 established via a network, which may include an IM CN 450, such as the IM CN shown in FIG. 2. The IM CN 450 may include a CSCF 452 and a MGF 458. The WTRU 410 may also receive control signals and media flows directly from the remote device without the use of the IM CN.

To establish a communication session 400 using IMS the WTRU 410 may initiate a connection (access leg) via the IM CN 450. In the access leg, the WTRU 410 may receive the media flows 430 via the MGF 458 and control signaling 440 via the CSCF 452. The WTRU 410, the remote unit 420, or both may maintain the communication and perform call control functions, such as session duplication, for the communication session 400. The remote device 420 may participate in the communication session 400 via a remote network (remote leg), such as via the Internet 460.

Session duplication may be performed for a communication session, such as the communication sessions shown in FIGS. 3 and 4. Session duplication may include adding one or more target WTRUs to the access leg of a communication session between a source WTRU and a remote device by duplicating the communication session, or a part of the communication session, on the target WTRUs without disrupting the communication session on the source WTRU or remote device. For example, a first media flow may be duplicated on a first target WTRU, and a second media flow may be duplicated on a second target WTRU. In another example, a first media flow may be duplicated on a first target WTRU and a second target WTRU. A target WTRU may be a separate physical unit (multi-unit session duplication), or it may be a separate physical interface in a single physical unit (multi-connection session duplication).

The source WTRU and the target WTRU may be associated via a collaborative session, which may be anchored in a third party, such as the SCC AS. The collaborative session, may be established prior to session duplication, or may be established during session duplication.

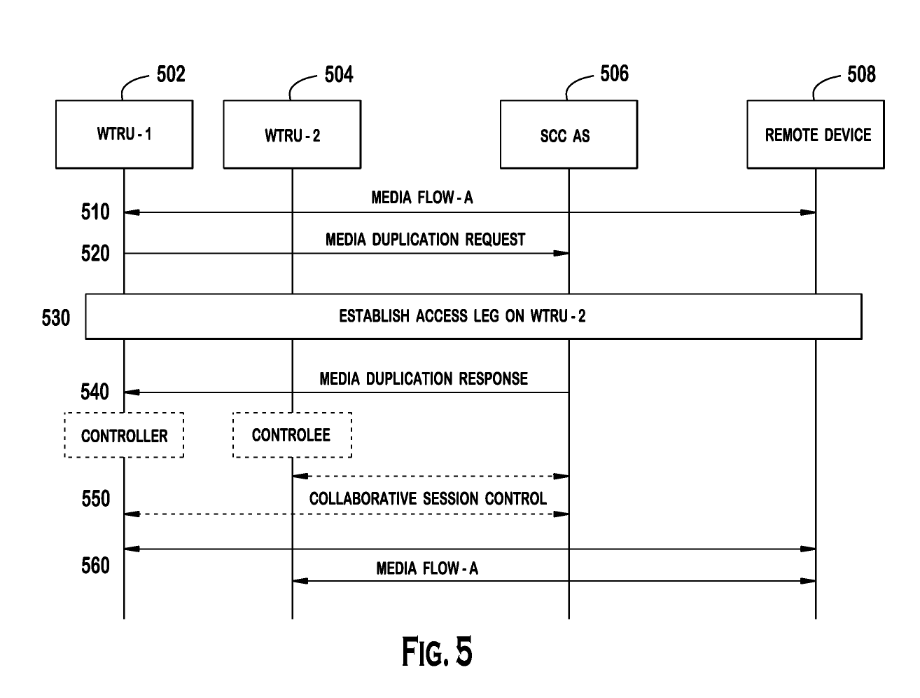

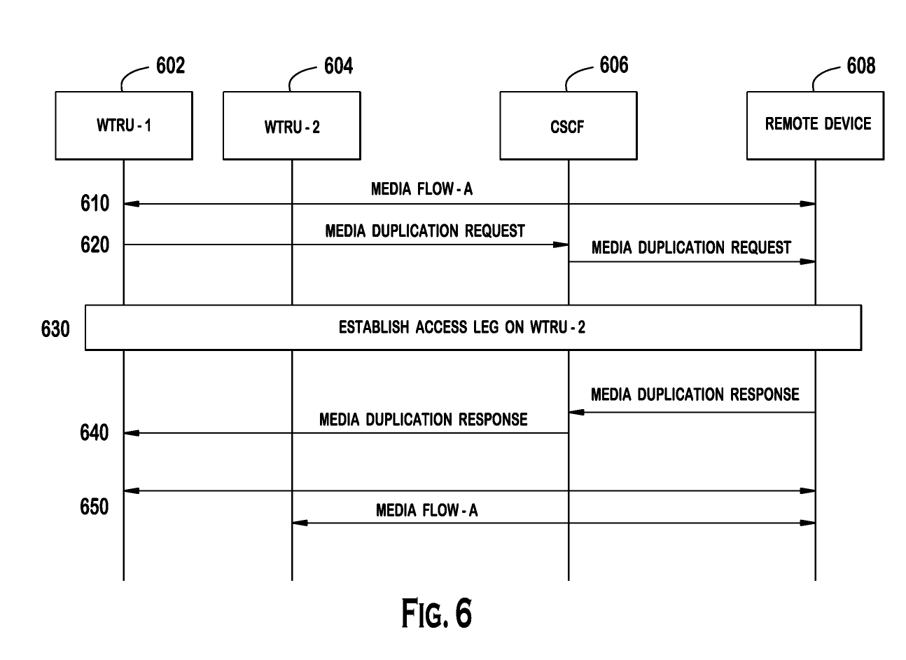

The source WTRU, the target WTRU, or the network, may initiate session duplication. For example, the source WTRU or the target WTRU may initiate session duplication in response to user input, context, or signal quality. In another example, a network device, such as a SCC AS, may initiate session duplication in response to a policy or a service interruption. The source WTRU may initially control the communication session, or may share control with the remote device. The source WTRU may pass control to the target WTRU or may share control with the target WTRU. Although FIGS. 5 and 6 show source WTRU 502/602 initiated session duplication for simplicity, target WTRU 504/604 initiated, or network initiated session duplication may be used.

FIG. 5 is a diagram of an example of a method of session duplication using IMS. A source WTRU 502 may be performing a communication session via an access leg at 510, including a Media Flow (Media Flow A), with a remote device 508, as shown in FIG. 3. For simplicity, only the SCC AS 506 is shown in FIG. 5; however, the communication paths may include other elements of the IM CN, as shown in FIGS. 2 and 3, and/or the RAN, as shown in FIGS. 1A and 1C. Although a single media flow and a single target WTRU 504 are shown, session duplication may include duplication of any number of communication sessions and media flows across any number of WTRUs.

The source WTRU 502 may initiate session duplication by sending a communication session duplication request to the SCC AS 506 at 520. The session duplication may be initiated based on, for example, information from Target WTRU 504, such as information received during discovery, or in response to input from a user or subscriber of the source WTRU 502. The request may include an identification of a target media flow (Media Flow A), an identification of a target WTRU (WTRU-2) 504, and may indicate the use of a collaborative session.

The SCC AS 506 may establish the access leg on the target WTRU 504, may duplicate Media Flow, and may send the duplicated media flow to the target WTRU 504 at 530. The SCC AS 506 may send a communication session duplication response the source WTRU 502 at 540 which may indicate that the duplication request was received and processed. The duplication response may indicate that the duplication request is accepted or that the request is denied, for example, due to an unsupported server, a lack or resources, or an inability to establish the access leg with the target WTRU 504.

The source WTRU 502 may maintain session control, such as in a collaborative session, and the target WTRU 504 may become the controlee WTRU at 550. Although FIG. 5 shows session control maintained by the source WTRU 502 for simplicity, the communication session may be controlled by the source WTRU 502, the target WTRU 504, the network, or any combination thereof.

The source WTRU 502 and the target WTRU 504 may each continue the communication session by performing the Media Flow at 560. Either the source WTRU 502 or the target WTRU 504 may cease performing the Media Flow. A controlling WTRU may terminate, or modify, the communication session.

FIG. 6 is a diagram of an example of a method of session duplication for a peer-to-peer communication session. A source WTRU 602 may be performing a communication session at 610, including a Media Flow (Media Flow A), with a remote device 608, via a network, such as the IM CN, as shown in FIG. 3. For simplicity, only the CSCF 606 is shown; however, the communication paths may include other elements of the IM CN, FIGS. 2 and 3, and/or the RAN, as shown in FIGS. 1A and 1C. In addition, although a single CSCF 606 is shown, the communication path may include multiple CFCFs, for example, the source WTRU 602, a target WTRU 604, and the remote device 608 may each be associated with a different CFCF. Although a single media flow and a single target WTRU 604 are shown, session duplication may include duplication of any number of communication sessions and media flows across any number of WTRUs.

The source WTRU 602 may initiate session duplication by sending a communication session duplication request to the Remote Device 608 via the CSCF 606 at 620. The session duplication may be initiated based on, for example, information from Target WTRU 604, such as information received during discovery, or in response to input from a user or subscriber of the source WTRU 602. The request may include an identification of a target media flow (Media Flow A), and an identification of a target WTRU 604.

The Remote Device 608 may establish the access leg on the target WTRU 604, may duplicate the Media Flow A, and may send the duplicate media flow to the target WTRU 604 at 630. The Remote Device 608 may send a communication session duplication response to the source WTRU 602 via the CSCF 606 at 640 which may indicate that the duplication request was received and processed. The duplication response may indicate that the duplication request is accepted or that the request is denied, for example, due to an unsupported server, a lack or resources, or an inability to establish the access leg with the target WTRU 604.

Although not shown in FIG. 6 for simplicity, session duplication for a peer-to-peer communication session may include session control and collaborative sessions. The communication session may be controlled by the source WTRU 502, the target WTRU 504, or both.

The source WTRU 602 and the target WTRU 604 may each continue the communication session by performing the Media Flow at 650. Either the source WTRU 602 or the target WTRU 604 may cease performing the Media Flow.

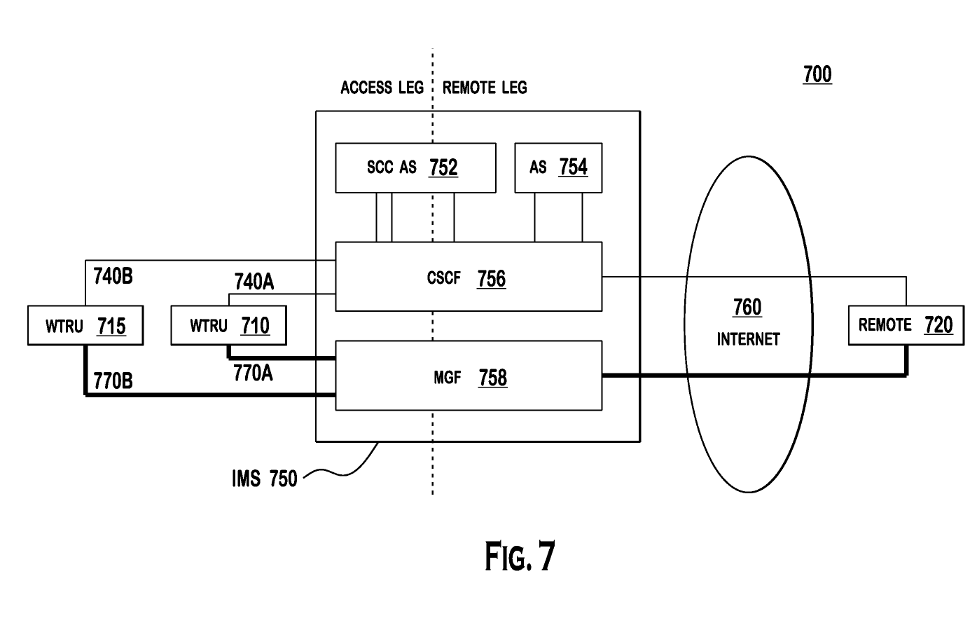

FIG. 7 shows a diagram of an example of a duplicated communication session 700. The source WTRU 710 and the target WTRU 715 may participate in the duplicated communication session 700 with the remote device 720 via a network 750, such as an IM CN as shown in FIG. 2. The IM CN 750 may include an SCC AS 752, an AS 754, a CSCF 756, and a MGF 758.

The communication session 700 may be anchored at the SCC AS 752 associated with the WTRU 710. For simplicity, the part of the communication session between the WTRUs 710/715 and the SCC AS 752 may be referred to as the access leg, and the part of the communication session between the SCC AS 752 and the remote device 720 may be referred to as the remote leg.

On the access leg, the source WTRU 710 and the target WTRU 715 may receive the duplicated media flows 770A/770B via the MGF 758 and the duplicated control signaling 740A/740B via the SCC AS 752 and the CSCF 756. The remote device 720 may participate in the communication session 700 via a remote network, such as via the Internet 760.

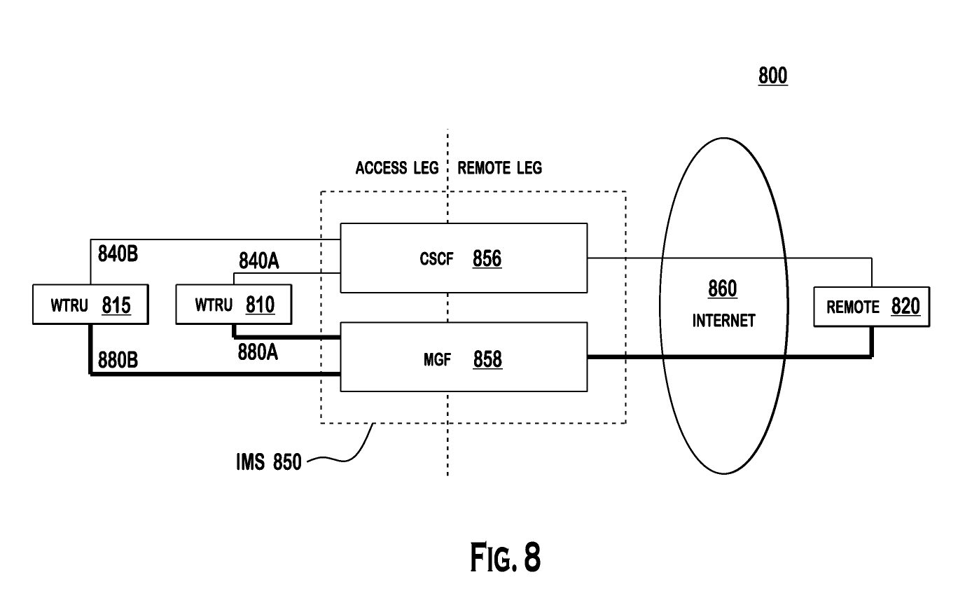

FIG. 8 shows a diagram of an example of a duplicated peer-to-peer communication session 800. The source WTRU 810 and the target WTRU 815 may participate in the duplicated peer-to-peer communication session 800 with the remote device 820 via a network 850, such as an IM CN as shown in FIG. 2. The IM CN 850 may include a CSCF 856, and a MGF 858.

For simplicity, the part of the communication session between the WTRUs 810/815 and the CSCF 856 may be referred to as the access leg, and the part of the communication session between the CSCF 856 and the remote device 820 may be referred to as the remote leg.

On the access leg, the source WTRU 810 and the target WTRU 815 may receive the duplicated media flows 880A/880B via the MGF 858 and the duplicated control signaling 840A/840B via the CS CF 856. The remote device 820 may participate in the communication session 800 via a remote network, such as via the Internet 860. Although FIG. 8 shows the media flow as being duplicated by the MGF 858, the media flows may be duplicated by the remote device 820, for example, using multiple transmitters.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed is:

1. A method for use in wireless communication, the method comprising:
transmitting a communication session duplication request from a first wireless transmit/receive unit (WTRU) to a first network, wherein the communication session duplication request indicates a communication session that is associated with a remote device; and
receiving the communication session at the first WTRU.

2. The method of claim 1, wherein the transmitting is performed on a condition that the communication session is associated with the first WTRU, and the communication session duplication request indicates a second WTRU.

3. The method of claim 1, wherein the transmitting is performed on a condition that the communication session is associated with a second WTRU.

4. The method of claim 1, wherein the communication session duplication request indicates a media flow and the receiving a communication session includes receiving the media flow.

5. The method of claim 1, wherein the transmitting includes transmitting the communication session duplication request to the remote device.

6. The method of claim 1, wherein the communication session duplication request indicates request to transfer session control.

7. The method of claim 1, wherein an apparatus includes the first WTRU; further comprising:
receiving the communication session at a second WTRU wherein the apparatus includes the second WTRU.

8. An apparatus for use in wireless communication, the apparatus comprising:
a first wireless transmit/receive unit (WTRU) configured to:
transmit a communication session duplication request to a first network, wherein the communication session duplication request indicates a communication session that is associated with a remote device; and
receive the communication session.

9. The apparatus of claim 8, wherein the first WTRU is configured to transmit on a condition that the communication session is associated with the first WTRU, and the communication session duplication request indicates a second WTRU.

10. The apparatus of claim 8, wherein the first WTRU is configured to transmit on a condition that the communication session is associated with a second WTRU.

11. The apparatus of claim 8, wherein the communication session duplication request indicates a media flow and the first WTRU is configured to receive the media flow.

12. The apparatus of claim 8, wherein the first WTRU is configured to transmit the communication session duplication request to the remote device.

13. The apparatus of claim 8, wherein an apparatus includes the first WTRU; further comprising:
receiving the communication session at a second WTRU wherein the apparatus includes the second WTRU.

14. A method for use in wireless communication, the method comprising:
receiving a communication session associated from a remote device;
transmitting the communication session to a first wireless transmit/receive unit (WTRU);
duplicating the communication session; and
transmitting the duplicated communication session to a second WTRU.

15. The method of claim 14, further comprising:
receiving a communication session duplication request indicating the communication session.
